(19) United States
(12) Patent Application Publication
(10) Pub. No.: US 2011/0187029 A1
(43) Pub. Date: Aug. 4, 2011

(54) ALIPHATIC-AROMATIC POLYESTER

(75) Inventors: Björn Dietrich, Neustadt (DE); Kai Oliver Siegenthaler, Mannheim (DE); Gabriel Skupin, Speyer (DE); Andreas Künkel, Speyer (DE); Motonori Yamamoto, Mannheim (DE)

(73) Assignee: BASF SE, Ludwigshafen (DE)

(21) Appl. No.: 13/121,535

(22) PCT Filed: Sep. 22, 2009
(86) PCT No.: PCT/EP2009/062258

§ 371 Date: Mar. 29, 2011

(30) Foreign Application Priority Data
Sep. 29, 2008 (EP) 08165372.7

(51) Int. Cl. B29C 49/02; C08L 5/00; C08L 89/00; C08L 75/06; C08J 9/35; B05D 3/12; C09J 163/00

(52) U.S. Cl. 264/539; 523/447; 523/449; 525/130; 521/81; 521/135; 427/358; 156/328; 156/330

(57) ABSTRACT

The present invention provides an aliphatic aromatic polyester comprising:
i) 40 to 60 mol %, based on components i to ii, of one or more dicarboxylic acid derivatives selected from the group consisting of: sebacic acid, azelaic acid and brassylic acid;
ii) 60 to 40 mol %, based on components i to ii, of a terephthalic acid derivative;
iii) 98 to 102 mol %, based on components i to ii, of 1,3-propanediol or 1,4-butanediol, and
iv) 0.01% to 5% by weight, based on the total weight of said components i to iii, of a chain extender and/or crosslinker selected from the group consisting of a polyfunctional isocyanate, isocyanurate, oxazoline, carboxylic anhydride, epoxide and/or an at least trihydric alcohol or an at least tribasic carboxylic acid.

The present invention further provides a process for producing the polyesters, polyester blends comprising these polyesters and also for the use of these polyesters and polyester blends.

The present invention provides an aliphatic aromatic polyester comprising:
i) 40 to 70 mol %, based on components i to ii, of one or more dicarboxylic acid derivatives or dicarboxylic acids selected from the group consisting of: sebacic acid, azelaic acid and brassylic acid;
ii) 60 to 30 mol %, based on components i to ii, of a terephthalic acid derivative;
iii) 98 to 102 mol %, based on components i to ii, of 1,3-propanediol or 1,4-butanediol, and
iv) 0.01% to 5% by weight, based on the total weight of said components i to iii, of a chain extender and/or crosslinker selected from the group consisting of a polyfunctional isocyanate, isocyanurate, oxazoline, carboxylic anhydride, epoxide, and/or an at least trihydric alcohol or an at least tribasic carboxylic acid.

The present invention further provides a process for producing the polyesters, polyester blends comprising these polyesters and also for the use of these polyesters and polyester blends.

WO-A 92/09654 describes aliphatic-aromatic polyesters that are biodegradable. It mentions in general terms that sebacic acid or azelaic acid is a useful aliphatic dicarboxylic acid.

WO-A 2006/097353 to 56 describe polybutylene terephthalate sebacates, azelates and brassylates. All of these references emphasize that the content of aromatic dicarboxylic acid is at least 49 and preferably more than 53 mol % in order that the requisite mechanical properties may be achieved. However, the high content of aromatic dicarboxylic acid leads to distinctly worse biodegradability.

It is an object of the present invention to synthesize polybutylene terephthalate azelates, brassylates and in particular sebacates that combine good mechanical properties with improved biodegradability.

We have found that this object is achieved by the polyesters described at the beginning, which surprisingly comply with the stipulated demand profile. This is achieved through the addition of 0.01% to 5% by weight, based on the total weight of components i to iii, of a chain extender and/or crosslinker selected from the group consisting of a polyfunctional isocyanate, isocyanurate, oxazoline, carboxylic anhydride, epoxide and/or an at least trihydric alcohol or an at least tribasic carboxylic acid. At the same time, these polyesters possess outstanding biodegradability.

Preferred aliphatic-aromatic polyesters are obtainable by condensation of
i) 52 to 65, preferably to 58 mol %, based on components i to ii, of one or more dicarboxylic acid derivatives or dicarboxylic acids selected from the group consisting of azelaic acid, brassylic acid and in particular sebacic acid;
ii) 48 to 35, preferably to 42 mol %, based on components i to ii, of a terephthalic acid derivative;
iii) 98 to 102 mol %, based on components i to ii, of 1,3-propanediol or 1,4-butanediol, and
iv) 0.01% to 5% by weight, based on the total weight of said components i to iii, of a chain extender and/or crosslinker selected from the group consisting of a polyfunctional isocyanate, isocyanurate, oxazoline, carboxylic anhydride such as maleic anhydride, epoxide (in particular an epoxy-containing poly(meth)acrylate and/or an at least trihydric alcohol or an at least tribasic carboxylic acid.

The polyesters described are generally synthesized in a two-stage reaction cascade. First, the dicarboxylic acid derivatives are reacted as in the synthesis examples together with 1,4-butanediol in the presence of a transesterification catalyst to form a prepolyester. The viscosity number (VN) of this prepolyester is generally in the range from 50 to 100 mL/g and preferably in the range from 60 to 90 mL/g. Zinc, aluminum and particularly titanium catalysts are typically used. Titanium catalysts such as tetraisopropyl orthotitanate and particularly tetrabutyl orthotitanate (TBOT) are superior to the tin, antimony, cobalt and lead catalysts frequently used in the literature, tin dioctanoate being an example, because any residual quantities of the catalyst or catalyst descendant which remain in the product are less toxic. This fact is particularly important for biodegradable polyesters, since they pass directly into the environment when used as composting bags or mulch sheeting for example.

The polyesters of the present invention are subsequently optionally chain-extended by following the processes described in WO 96/15173 and EP-A 488 617. The prepolyester is reacted for example with chain extenders vib), such as with diisocyanates or with epoxy-containing polymethacrylates, in a chain-extending reaction to form a polyester having a viscosity number of 60 to 450 mL/g, preferably 80 to 250 mL/g.

A mixture of the dicarboxylic acids is generally initially condensed in the presence of an excess of diol together with the catalyst. Subsequently, the melt of the prepolyester thus obtained is typically condensed at an internal temperature of 200 to 250° C. during 3 to 6 hours at reduced pressure, with distillative removal of released diol, to the desired viscosity with a viscosity number (VN) of 60 to 450 mL/g and preferably 80 to 250 mL/g.

The polyesters of the present invention are more preferably produced by following the continuous process described in EP application No. 08154541.0. In this process, for example, a mixture of 1,4-butanediol, sebacic acid, terephthalic acid and, optionally, further comonomers is mixed, without addition of a catalyst, to form a paste, or, as an alternative, the liquid esters of the dicarboxylic acids are fed into the reactor, as also are the dihydroxy compound and, optionally, further comonomers, without addition of a catalyst, and
1. in a first stage, this mixture is continuously esterified or, respectively, transesterified together with all or some of the catalyst;
2. in a second stage, the transesterification/esterification product obtained as per 1.) is, if appropriate together with the rest of the catalyst, precondensed—preferably in a tower reactor where the product stream is passed cocurrently over a falling-film cascade and the reaction vapors are removed in situ from the reaction mixture—to a DIN 53728 viscosity number of 20 to 60 mL/g;
3. in a third stage, the product obtainable from 2.) is continuously polycondensed—preferably in a cage reactor—to a DIN 53728 viscosity number of 70 to 130 mL/g, and
4. in a fourth stage, the product obtainable from 3.) is continuously reacted with a chain extender in a polyaddition reaction in an extruder, List reactor or static mixer as far as a DIN 53728 viscosity number of 80 to 250 mL/g.

The abovementioned viscosity number ranges merely serve as indicators for preferred process variations and shall not be deemed limiting in respect of the present invention.

In addition to the continuous process described above, the polyesters of the present invention can also be produced in a batch operation. To this end, the aliphatic and the aromatic dicarboxylic acid derivative and the diol and optionally a branching agent are mixed in any desired order of addition and condensed to form a prepolymer. Optionally, a chain extender can be used to achieve a polyester having the desired viscosity number.

The abovementioned process provides for example polybutylene terephthalate azelates, brassylates and in particular sebacates having a DIN EN 12634 acid number of less than 1.0 mg KOH/g and a viscosity number of greater than 130 mL/g and also an ISO 1133 MVR of less than 6 cm³/10 min (190° C., 2.16 kg weight). These products are useful for film applications in particular.

For other applications, polyesters of the present invention having a higher ISO 1133 MVR of up to 30 cm³/10 min (190° C., 2.16 kg weight) may be useful. The polyesters generally have an ISO 1133 MVR of 1 to 30 cm³/10 min and preferably 2 to 20 cm³/10 min (190° C., 2.16 kg weight).

The aliphatic dicarboxylic acid i is used in 40 to 70 mol %, preferably 52 to 65 mol % and more preferably 52 to 58 mol %, based on acid components i and ii. Sebacic acid, azelaic acid and brassylic acid are obtainable from renewable raw materials, in particular from plant oils such as for example castor oil.

Terephthalic acid ii is used in 60 to 30 mol %, preferably 48 to 35 mol % and more preferably 48 to 42 mol %, based on acid components i and ii.

Terephthalic acid and the aliphatic dicarboxylic acid can be used either as free acid or in the form of ester-forming derivatives. Useful ester-forming derivatives include particularly the di-C₁- to C₆-alkyl esters, such as the dimethyl, diethyl, di-n-propyl, diisopropyl, di-n-butyl, diisobutyl, di-t-butyl, di-n-pentyl, diisopentyl or di-n-hexyl esters. Anhydrides of the dicarboxylic acids can likewise be used.

The dicarboxylic acids or their ester-forming derivatives can be used individually or in the form of a mixture.

1,4-Butanediol is likewise obtainable from renewable raw materials. PCT/EP2008/006714 discloses a biotechnological process for production of 1,4-butanediol from different carbohydrates using microorganisms from the class of the Pasteurellaceae.

In general, at the start of the polymerization, the diol (component iii) is adjusted relative to the acids (components i and ii) such that the ratio of diol to diacids be in the range from 1.0:1 to 2.5:1 and preferably in the range from 1.3:1 to 2.2:1. Excess quantities of diol are withdrawn during the polymerization, so that an approximately equimolar ratio becomes established at the end of the polymerization. By “approximately equimolar” is meant a diol/diacids ratio in the range from 0.98:1 to 1.02:1.

The polyesters mentioned may have hydroxyl and/or carboxyl end groups in any desired proportion. The partly aromatic polyesters mentioned can also be subjected to end group modification. For instance, OH end groups can be acid modified by reaction with phthalic acid, phthalic anhydride, trimellitic acid, trimellitic anhydride, pyromellitic acid or pyromellitic anhydride. Preference is given to polyesters having acid numbers of less than 1.5 mg KOH/g.

Generally 0.01% to 5% by weight, preferably 0.02% to 3% by weight and more preferably 0.05% to 2% by weight based on the total weight of components i to iii of a crosslinker iva and/or chain extender ivb selected from the group consisting of a polyfunctional isocyanate, isocyanurate, oxazoline, epoxide, carboxylic anhydride, an at least trihydric alcohol or an at least tribasic carboxylic acid is used. Useful chain extenders ivb include polyfunctional and particularly difunctional isocyanates, isocyanurates, oxazolines, carboxylic anhydride or epoxides. The crosslinkers iva) are generally used in a concentration of 0.01% to 5% by weight, preferably 0.02% to 1% by weight and more preferably 0.05% to 0.5% by weight based on the total weight of components i to iii. The chain extenders ivb) are generally used in a concentration of 0.01% to 5% by weight, preferably 0.2% to 4% by weight and more preferably 0.35% to 2% by weight based on the total weight of components i to iii.

Chain extenders and also alcohols or carboxylic acid derivatives having three or more functional groups can also be considered as crosslinkers. Particularly preferred compounds have three to six functional groups. Examples are tartaric acid, citric acid, malic acid; trimethylolpropane, trimethyolethane; pentaerythritol; polyethertriols and glycerol, trimesic acid, trimellitic acid, trimellitic anhydride, pyromellitic acid and pyromellitic anhydride. Preference is given to polyols such as trimethylolpropane, pentaerythritol and particularly glycerol. Components iv can be used to construct biodegradable polyesters which are pseudoplastic having structural viscosity. Melt rheology improves; the biodegradable polyesters are easier to process, for example easier to draw into self-supporting film/sheet by melt-solidification. Compounds Iv have a shear-thinning effect, and viscosity therefore decreases under load.

The term “epoxides” is to be understood as meaning particularly epoxy-containing copolymer based on styrene, acrylic ester and/or methacrylic ester. The units which bear epoxy groups are preferably glycidyl (meth)acrylates. Copolymers having a glycidyl methacrylate content of greater than 20%, more preferably greater than 30% and even more preferably greater than 50% by weight of the copolymer will be found particularly advantageous. The epoxy equivalent weight (EEW) in these polymers is preferably in the range from 150 to 3000 and more preferably in the range from 200 to 500 g/equivalent. The weight average molecular weight M_{w} of the polymers is preferably in the range from 2000 to 25 000 and particularly in the range from 3000 to 8000. The number average molecular weight Mₙ of the polymers is preferably in the range from 400 to 6000 and particularly in the range from 1000 to 4000. The polydispersity (Q) is generally between 1.5 and 5. Epoxy-containing copolymers of the abovementioned type are commercially available, for example from BASF Resins B.V. under the Joncryl® ADR brand. Joncryl® ADR 4368 is particularly useful as chain extender.

It is generally sensible to add the crosslinking (at least trifunctional) compounds at an early stage of the polymerization.

Useful bifunctional chain extenders include the following compounds:

An aromatic diisocyanate ivb comprises in particular tolylene 2,4-diisocyanate, tolylene 2,6-diisocyanate, 2,2′-diphenylmethane diisocyanate, 2,4′-diphenylmethane diisocyanate, 4,4′-diphenylmethane diisocyanate, naphthylene 1,5-diisocyanate or xylylene diisocyanate. Of these, particular preference is given to 2,2′-, 2,4′- and also 4,4′-diphenylmethane diisocyanates. In general, the latter diisocyanates are used as a mixture. The diisocyanates will also comprise minor amounts, for example up to 5% by weight, based on the total weight, of urethione groups, for example for capping the isocyanate groups.

The term “aliphatic diisocyanate” herein refers particularly to linear or branched alkylene diisocyanates or cycloalkylene diisocyanates having 2 to 20 carbon atoms, preferably 3 to 12 carbon atoms, for example 1,6-hexamethylene diisocyanate, isophorone diisocyanate or methylenebis(4-isocyanatocyclohexane). Particularly preferred aliphatic diisocyanates are isophorone diisocyanate and, in particular, 1,6-hexamethylene diisocyanate.

The preferred isocyanurates include the aliphatic isocyanurates which derive from alkylene diisocyanates or cycloalkylene diisocyanates having 2 to 20 carbon atoms, preferably 3 to 12 carbon atoms, for example isophorone diisocyanate or methylenebis(4-isocyanatocyclohexane). The alkylene diisocyanates here may be either linear or branched. Particular preference is given to isocyanurates based on n-hexamethylene diisocyanate, for example cyclic trimers, pentamers or higher oligomers of 1,6-hexamethylene diisocyanate.

2,2′-Bisoxazolines are generally obtainable via the process from Angew. Chem. Int. Ed., Vol. 11 (1972), S. 287-288. Particularly preferred bisoxazolines are those in which R¹ is a single bond, a (CH₂)_{z} alkylene group, where z=2, 3 or 4, such as methylene, 1,2-ethanediyl, 1,3-propanediyl, 1,2-propanediyl or a phenylene group. Particularly preferred bisoxazolines are 2,2′-bis(2-oxazoline), bis(2-oxazolinyl)methane, 1,2-bis(2-oxazolinyl)ethane, 1,3-bis(2-oxazolinyl)propane or 1,4-bis(2-oxazolinyl)butane, in particular 1,4-bis(2-oxazolinyl)benzene, 1,2-bis(2-oxazolinyl)benzene or 1,3-bis(2-oxazolinyl)benzene.

The number average molecular weight (Mn) of the polyesters of the present invention is generally in the range from 5000 to 100 000, particularly in the range from 10 000 to 60 000 g/mol, preferably in the range from 15 000 to 38 000 g/mol, their weight average molecular weight (Mw) is generally in the range from 30 000 to 300 000, preferably 60 000 to 200 000 g/mol, and their Mw/Mn ratio is generally in the range from 1 to 6, preferably in the range from 2 to 4. The viscosity number is generally between 30 and 450 g/mL, preferably in the range from 50 to 400 g/mL and more preferably in the range from 80 to 250 mL/g (measured in 50:50 w/w o-dichlorobenzene/phenol). The melting point is in the range from 85 to 150° C. and preferably in the range from 95 to 140° C.

One preferred embodiment comprises adding 1% to 80% by weight, based on the total weight of components i to iv, of an organic filler selected from the group consisting of native or plasticized starch, natural fibers, wood meal, comminuted cork, ground bark, nut shells, ground presscakes (vegetable oil refining), dried production residues from the fermentation or distillation of beverages such as, for example, beer, brewed lemonades (for example Bionade), wine or sake and/or an inorganic filler selected from the group consisting of chalk, graphite, gypsum, conductivity carbon black, iron oxide, calcium chloride, dolomite, kaolin, silicon dioxide (quartz), sodium carbonate, titanium dioxide, silicate, wollastonite, mica, montmorillonites, talcum, glass fibers and mineral fibers.

Starch and amylose may be native, i.e., non-thermoplasticized, or they may be thermoplasticized with plasticizers such as glycerol or sorbitol for example (EP-A 539 541, EP-A 575 349, EP 652 910).

Examples of natural fibers are cellulose fibers, hemp fibers, sisal, kenaf, jute, flax, abacca, coir fiber or else regenerated cellulose fibers (rayon) such as, for example, Cordenka fibers.

Preferred fibrous fillers are glass fibers, carbon fibers, aramid fibers, potassium titaniuim fibers and natural fibers, of which glass fibers in the form of E-glass are particularly preferred. These can be used as rovings or particularly as chopped glass in the commercially available forms. The diameter of these fibers is generally in the range from 3 to 30 μm, preferably in the range from 6 to 20 μm and more preferably in the range from 8 to 15 μm. The fiber length in the compound is generally in the range from 20 μm to 1000 μm, preferably in the range from 180 to 500 μm and more preferably in the range from 200 to 400 μm.

The fibrous fillers may have been surface-pretreated, with a silane compound for example, for superior compatibility with the thermoplastic.

Suitable silane compounds are those of the general formula

(X—(CH₂)ₙ)ₖ—Si—(O—CₘH₂ₘ₊₁)₄₋ₖ

where

### X is NH₂—,

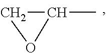

### HO—,

n is a whole number from 2 to 10, preferably 3 to 4
m is a whole number from 1 to 5, preferably 1 or 2
k is a whole number from 1 to 3, preferably 1.

Preferred silane compounds are aminopropyltrimethoxysilane, aminobutyltrimethoxy-silane, aminopropyltriethoxysilane, aminobutyltriethoxysilane and also the corresponding silanes which comprise a glycidyl group as substituent X, or halosilanes.

The amount of silane compound used for surface coating is generally in the range from 0.01% to 2%, preferably 0.025% to 1.0% and particularly 0.05% to 0.5% by weight (based on C).

The biodegradable polyester blends of the present invention may comprise further ingredients which are known to a person skilled in the art but which are not essential to the present invention. Examples are the materials customarily added in plastics technology, such as stabilizers; nucleating agents, neutralizing agents; lubricating and release agents such as stearates (particularly calcium stearate); plasticizers such as for example citric esters (particularly tributyl acetylcitrate), glyceric esters such as triacetylglycerol or ethylene glycol derivatives, surfactants such as polysorbates, palmitates or laurates, waxes such as for example beeswax or beeswax ester; antistat, UV absorber; UV stabilizer; antifog agent or dyes. The additives are used in concentrations of 0% to 5% by weight and particularly 0.1% to 2% by weight based on the polyesters of the present invention. Plasticizers may be present in the polyesters of the present invention at 0.1% to 10% by weight.

The biodegradable polyester blends of the present invention are produced from the individual components by following known processes (EP 792 309 and U.S. Pat. No. 5,883,199). For example, all the blending partners can be mixed and reacted in one process step in mixing apparatuses known to one skilled in the art, for example kneaders or extruders, at elevated temperatures, for example in the range from 120° C. to 250° C.

Typical copolymer blends comprise:
5% to 95% by weight, preferably 20% to 80% by weight and more preferably 40% to 70% by weight of a polyester of the present invention and
95% to 5% by weight, preferably 80% to 20% by weight and more preferably 60% to 30% by weight of one or more polymers selected from the group consisting of polylactic acid, polycaprolactone, polyhydroxyalkanoate, chitosan and gluten and one or more polyesters based on aliphatic diols and aliphatic/aromatic dicarboxylic acids such as for example polybutylene succinate (PBS), polybutylene succinate adipate (PBSA), polybutylene succinate sebacate (PBSSe), polybutylene terephthalate-co-adipate (PBTA), and
0% to 2% by weight of a compatibilizer.

The copolymer blends preferably comprise in turn 0.05% to 2% by weight of a compatibilizer. Preferred compatibilizers are carboxylic anhydrides such as maleic anhydride and particularly the above-described epoxy-containing copolymers based on styrene, acrylic ester and/or methacrylic ester. The epoxy-bearing units are preferably glycidyl (meth)acrylates. Epoxy-containing copolymers of the abovementioned type are commercially available, for example from BASF Resins B.V. under the Joncryl® ADR brand. Joncryl® ADR 4368 for example is particularly useful as a compatibilizer.

Particularly preferred polyester blends comprise
40% to 70% by weight of a polyester according to claims 1 to 4 and
60% to 30% by weight of one or more polymers selected from the group consisting of polylactic acid and polyhydroxyalkanoate, and
0% to 2% by weight of an epoxy-containing poly(meth)acrylate.

Polylactic acid for example is useful as a biodegradable polyester. Polylactic acid having the following profile of properties is preferably used:
an ISO 1133 MVR melt volume rate at 190° C. and 2.16 kg of 0.5 to 30, preferably 2 to 18 ml/10 minutes
a melting point below 240° C.;
a glass transition point Tg above 55° C.
a water content of less than 1000 ppm
a residual monomer content (lactide) of less than 0.3%
a molecular weight of greater than 80 000 daltons.

Preferred polylactic acids are for example NatureWorks® 3001, 3051, 3251, 4020, 4032 or 4042D (polylactic acid from NatureWorks or NL-Naarden and USA Blair/Nebraska).

Polyhydroxyalkanoates are primarily poly-4-hydroxybutyrates and poly-3-hydroxybutyrates, but further comprise copolyesters of the aforementioned hydroxybutyrates with 3-hydroxyvalerates or 3-hydroxyhexanoate. Poly-3-hydroxybutyrate-co-4-hydroxybutyrates are known from Metabolix in particular. They are marketed under the trade name of Mirel®. Poly-3-hydroxybutyrate-co-3-hydroxyhexanoates are known from P&G or Kaneka. Poly-3-hydroxybutyrates are marketed for example by PHB Industrial under the trade name of Biocycle® and by Tianan under the name of Enmat®.

The molecular weight Mw of the polyhydroxyalkanoates is generally in the range from 100 000 to 1 000 000 and preferably in the range from 300 000 to 600 000.

Partly aromatic polyesters based on aliphatic diols and aliphatic/aromatic dicarboxylic acids also comprise polyester derivatives such as polyether esters, polyester amides or polyether ester amides. Suitable partly aromatic polyesters include linear non-chain-extended polyesters (WO 92/09654). Aliphatic/aromatic polyesters formed from butanediol, terephthalic acid and aliphatic C₆-C₁₈-dicarboxylic acids such adipic acid, suberic acid, azelaic acid, sebacic acid and brassylic acid (as described in WO 2006/097353 to 56, for example) are useful blending partners in particular. Preference is given to chain-extended and/or branched partly aromatic polyesters. The latter are known from the above-cited references WO 96/15173 to 15176, 21689 to 21692, 25446, 25448 or WO 98/12242, which are each expressly incorporated herein by reference. Mixtures of different partly aromatic polyesters are similarly suitable. Partly aromatic polyesters are to be understood as meaning in particular products such as Ecoflex® (BASF SE), Eastar® Bio and Origo-Bi® (Novamont).

Polycaprolactone is marketed by Daicel under the product name of Placcel®.

The polyesters and polyester blends of the present invention have superior biodegradability to the polybutylene terephthalate azelates, brassylates and in particular sebacates disclosed in WO-A 2006/097353 and WO-A 2006/097354 combined with good mechanical properties.

The “biodegradable” feature shall for the purposes of the present invention be considered satisfied for any one material or composition of matter when this material or composition of matter has a DIN EN 13432 percentage degree of biodegradation equal to at least 90%.

The general effect of biodegradability is that the polyester (blends) decompose within an appropriate and verifiable interval. Degradation may be effected enzymatically, hydrolytically, oxidatively and/or through action of electromagnetic radiation, for example UV radiation, and may be predominantly due to the action of microorganisms such as bacteria, yeasts, fungi and algae. Biodegradability can be quantified, for example, by polyesters being mixed with compost and stored for a certain time. According to DIN EN 13432 (citing ISO 14855), for example, CO₂-free air is flowed through ripened compost during composting and the ripened compost subjected to a defined temperature program. Biodegradability here is defined via the ratio of the net CO₂ released by the sample (after deduction of the CO₂ released by the compost without sample) to the maximum amount of CO₂ releasable by the sample (reckoned from the carbon content of the sample), as a percentage degree of biodegradation. Biodegradable polyesters/polyester blends typically show clear signs of degradation, such as fungal growth, cracking and holing, after just a few days of composting.

Other methods of determining biodegradability are described in ASTM D 5338 and ASTM D 6400-4 for example.

The polyesters of the present invention are useful for producing adhesives, dispersions, moldings, extruded foams, bead foams, self-supporting film/sheet and film ribbons for nets and fabrics, tubular film, chill roll film with and without orientation in a further operation, with and without metallization or SiOₓ coating. Molded articles are particularly molded articles having wall thicknesses above 200 μm, which are obtainable using molding processes such as injection molding, injection blow molding, extrusion/thermoforming, extrusion blow molding and calendering/thermoforming.

Interesting fields of application because of the good biodegradability include catering cutlery, plates, plant pots, tiles, refillable containers and closures for non-food applications such as detergents or agricultural products and food products (semi-hard packaging for cheese, cold meat, etc.), extrusion-blown or injection stretch blown moldings such as bottles, beverage bottles, bottles for other contents, twisted lid containers for cosmetics, etc. Contemplated in particular are bottles or pots for food products from dairies such as milk or milk products, from the fat industry or from the confectionery industry (icecream, bars, industrial bakery) and frozen food industry.

The polyesters of the present invention are particularly useful for blown film applications such as for example inliners, flexible intermediate bulk containers, carrier bags, freezer bags, composting bags, agricultural film/sheeting (mulch films), film bags for packaging food.

Owing to the rapid degradability and the outstanding mechanical properties it is possible to realize film applications which meet compostability standards even at comparatively high film thicknesses (>240 μm).

The polyesters of the present invention additionally have very good adherence properties. This makes them very useful for paper coating, for example for paperboard cups and paperboard plates. Extrusion coating and also lamination techniques are suitable for their production. A combination of these processes is also conceivable.

Extrusion coating was developed to apply thin polymeric layers to flexible substrates such as paper, card or multilayered foils with metal coat at high web speeds of 100-600 m/min. The polyesters of the present invention protect the substrate from oil, fat and moisture, and enables through its weldability to itself and paper, card and metal the manufacture of, for example, coffee cups, drink cartons or cartons for frozen goods. The polyesters of the present invention can be processed on existing extrusion coating machinery for polyethylene (J. Nentwig: Kunststofffolien, Hanser Verlag, Munich 2006, p. 195; H. J. Saechtling: Kunststoff Taschenbuch, Hanser Verlag, Munich 2007, p. 256; C. Rauwendaal: L Polymer Extrusion, Hanser Verlag, Munich 2004, p. 547.)

As well as enhanced adhesion to paper and card, the polyesters and polyester blends of the present invention are superior to existing solutions in extrusion coating by showing less proneness to melt resonance, making it possible to use increased track speeds in the coating operation and achieve a significant saving of material.

### Performance-Related Measurements:

The molecular weight Mn and Mw of partly aromatic polyesters were determined as follows:

15 mg of partly aromatic polyester were dissolved in 10 ml of hexafluoroisopropanol (HFIP). 125 μl at a time of this solution were analyzed by means of gel permeation chromatography (GPC). The measurements were carried out at room temperature. HFIP+0.05% by weight of potassium trifluoroacetate was used for elution. The elution rate was 0.5 ml/min. The column combination used was as follows (all columns from Showa Denko Ltd., Japan): Shodex® HFIP-800P (diameter 8 mm, length 5 cm), Shodex® HFIP-803 (diameter 8 mm, length 30 cm), Shodex® HFIP-803 (diameter 8 mm, length 30 cm). The partly aromatic polyesters were detected by means of an RI detector (differential refractometry). Narrowly distributed polymethyl methacrylate standard having molecular weights of Mₙ=505 to Mₙ=2 740 000 were used for calibration. Elution ranges outside this interval were determined by extrapolation.

Viscosity numbers were determined in accordance with DIN 53728 Part 3, Jan. 3, 1985, Capillary Viscometry. A type M-II Micro-Ubbelohde viscometer was used. The solvent used was the 50/50 w/w phenol/o-dichlorobenzene mixture.

Modulus of elasticity, breaking strength and breaking extension were determined by means of a tensile test on pressed sheets about 420 μm in thickness in accordance with ISO 527-3: 2003.

A puncture resistance test on pressed sheets 420 μm in thickness was used to measure the ultimate strength and the fracture energy of the polyesters:

The testing machinery used was a Zwick 1120 equipped with a spherical dolly having a diameter of 2.5 mm. The sample, a circular piece of the sheet to be measured, was clamped perpendicularly relative to the dolly and this dolly was moved at a constant test speed of 50 mm/min through the plane of the clamping device. Force and extension were recorded during the test and used to determine puncture energy.

The degradation rates of the biodegradable polyester blends and of the comparative blends were determined as follows:

The biodegradable polyester blends and the blends produced for comparison were each pressed at 190° C. to form films 30 μm in thickness. These films were each cut into square pieces having an edge length of 2×5 cm. The weight of each film piece was determined and defined as “100% weight”. The film pieces were heated for four weeks in a drying cabinet to 58° C. in a plastics tin filled with moistened composting earth. The remaining weight of the film pieces was measured at weekly intervals and converted to percent weight (based on the weight determined at the start of the test and defined as “100% weight”).

### EXAMPLES

### Example 1

### Polybutylene terephthalate-sebacate—Comparative Experiment (See Example 1 of WO 2006/097353)

(Molar ratio of terephthalic acid:sebacic acid=53.5:46.5—not chain-extended)

48.77 g of dimethyl terephthalate, 55.00 g of 1,4-butanediol, 0.12 g of glycerol and 0.09 mL of tetrabutyl orthotitanate (TBOT) were initially charged to a 250 mL four-neck flask and the apparatus was purged with nitrogen. Methanol was distilled off up to an internal temperature of 200° C. This was followed by cooling down to about 160° C., at which point 44.15 g of sebacic acid were added and water was distilled off at up to an internal temperature of 200° C. The temperature was lowered to about 160° C., followed by condensation in vacuo (<5 mbar) at up to an internal temperature of 250° C. Once the desired viscosity was reached, the flask was cooled down to room temperature.

VN=83 mL/g

### Example 2

### Polybutylene terephthalate-adipate—Comparative Experiment (See Example 3 of WO 2006/097353)

(Terephthalic acid:adipic acid=47:53—not chain-extended)

The polybutylene terephthalate-adipate was prepared as per example 1 but with the corresponding amount of adipic acid instead of sebacic acid. The molar ratio of terephthalic acid to adipic acid was 47:53

Viscosity number VN=96 mL/g

### Example 3

### Polybutylene terephthalate-adipate—Comparative Experiment (See WO-A 96/15173)

(Terephthalic Acid:Adipic Acid=47:53—Chain Extended)

Chain extension was carried out in a Rheocord 9000 Haake kneader with a Rheomix 600 attachment. The prepolyester (example 2) was melted at 220° C. and the melt was admixed dropwise with the desired amount of HDI (hexamethylene diisocyanate) (3a: 0.3% by weight, 3b: 0.6% by weight, 3c: 0.9% by weight, 3d: 1.2% by weight). Progress of the reaction was monitored by observing the torque. Once maximum torque was reached, the reaction mixture was cooled down, and the chain-extended biodegradable polyester was removed and characterized. Viscosity numbers see table.

### Example 4

### Polybutylene terephthalate-sebacate Comparative Experiment (See Example 2 of WO 2006/097353)

(Terephthalic acid:sebacic acid=47:53—Comparative experiment)

The prepolyester was prepared similarly to example 1 using the following starting materials: dimethyl terephthalate (350.55 g), 1,4-butanediol (450.00 g), glycerol (1.21 g), TBOT (1.3 g), sebacic acid (411.73 g).

VN=80 mL/g

### Example 5

### Polybutylene terephthalate-sebacate—

(Terephthalic acid:sebacic acid=47:53—chain extended)

Chain extension was carried out in a Rheocord 9000 Haake kneader with a Rheomix 600 attachment. The prepolyester (example 4) was melted at 220° C. and the melt was admixed dropwise with the desired amount of HDI (hexamethylene diisocyanate) (5a: 0.3% by weight, 5b: 0.6% by weight, 5c: 0.9% by weight, 5d: 1.2% by weight). Progress of the reaction was monitored by observing the torque. Once maximum torque was reached, the reaction mixture was cooled down, and the chain-extended biodegradable polyester was removed and characterized. Viscosity numbers see table.

TABLE 1
Mechanical data

| | | E | Breaking | Breaking | Damaging | Puncture |
|---|---|---|---|---|---|---|
| | VN | modulus | strength | extension | force | energy |
| Example | [mL/g] | [MPa] | [MPa] | [%] | [N] | [N mm] |
| V-1 | 83 | 87 | 8.91 | 414 | 17.93 | 89.67 |
| V-2 | 96 | 94 | 17.93 | 785 | 18.29 | 96.54 |
| V-3a | 112 | 94 | 16.99 | 733 | 17.72 | 94.97 |
| V-3b | 123 | 96 | 18.58 | 771 | 17.39 | 108.76 |
| V-3c | 130 | 93 | 19.66 | 803 | 18.56 | 118.79 |
| V-3d | 139 | 91 | 24.22 | 920 | 19.98 | 124.86 |
| V-4 | 80 | 63 | 5.21 | 251 | 12.42 | 61.5 |
| 5a | 103 | 48 | 7.48 | 687 | 12.47 | 79.42 |
| 5b | 130 | 54 | 12.83 | 997 | 13.54 | 103.61 |
| 5c | 156 | 47 | 20.02 | 1088 | 19.11 | 149.81 |
| 5d | 253 | 53 | 28.71 | 1196 | 24.68 | 218.09 |

The polyesters of the present invention have numerous advantages:

Chain-extended PBSeT also displays a distinctly enhanced degradation rate compared with chain-extended PBAT. This was evidenced not only in a controlled composting test of polymer powder at 58° C. by determining the amount of CO₂ released during composting but also by disintegration tests by the above-described method on film samples 120 or 240 μm in thickness.

While PBAT (comparative example V-3c) reaches 80% of the theoretical CO₂ release after 64 days, this is the case with PBSeT of comparable composition (example 5c) after just 33 days, corresponding to twice the rate of degradation. Moreover, in disintegration tests, distinctly thicker samples of PBSeT (example 5c) can be degraded than PBAT (comparative example V-3c) within the normative requirements: whereas a PBAT film 120 μm in thickness disintegrates within 6 weeks, the complete disintegration of a PBSeT film 240 μm in thickness can be realized within the same time span.

PBSeT without chain extension (example V-4) and chain-extended PBSeT (example 5c) have comparable biodegradation rates (see table 2).

TABLE 2
percentage weight losses of comparative
example 4 and of inventive example 5c

| Time | Comparative example 4 | Inventive example 5c |
|---|---|---|
| [weeks] | Weight loss in [%] | Weight loss in [%] |
| 1 | 37 | 27 |
| 2 | 67 | 56 |
| 3 | 71 | 63 |
| 4 | 83 | 68 |

The results in table 2 show that the chain extension of PBSeT prepolyesters to long-chain PBSeT polyester urethanes does not lead to a significant change in the rate of degradation. Both the materials are completely disintegrated after 5 weeks. A comparison with the results published in WO-A 2006/097353 and WO-A 2006/097354 clearly shows that the chain extension of aliphatic-aromatic copolyesters which is described in the present invention does not just lead to better mechanical properties but also ensures the advantageous property of a distinctly faster biodegradability.

Chain-extended PBSeT having a comparatively low terephthalic acid content (example 5c) degrades much faster than the comparative PBSeT (example V-1) from WO 2006/097353 A1.

Owing to the rapid degradability and the outstanding mechanical properties it is possible to realize film applications which meet compostability standards even at comparatively high film thicknesses (>240 μm).

1.-11. (canceled)

12. A polyester blend comprising:
5% to 95% by weight of a polyester comprising:
i) 52 to 65 mol %, based on components i to ii, of one or more dicarboxylic acid derivatives or dicarboxylic acids selected from the group consisting of: sebacic acid, azelaic acid and brassylic acid;
ii) 48 to 35 mol %, based on components i to ii, of a terephthalic acid derivative;
iii) 98 to 102 mol %, based on components i to ii, of 1,3-propanediol or 1,4-butanediol, and
iv) 0.01% to 5% by weight, based on the total weight of said components i to iii, of a chain extender and/or crosslinker selected from the group consisting of a polyfunctional isocyanate, isocyanurate, oxazoline, epoxide, carboxylic anhydride, an at least trihydric alcohol and an at least tribasic carboxylic acid and
95% to 5% by weight of one or more polymers selected from the group consisting of polylactic acid, polycaprolactone, polyhydroxyalkanoate, chitosan, gluten and one or more aliphatic/aromatic polyesters and
0.05% to 2% by weight of an epoxy-containing copolymer based on styrene, acrylic ester and/or methacrylic ester as compatibilizer.

13. The polyester blend according to claim 12, wherein in iv) said epoxide is an epoxy-containing poly(meth)acrylate and
95% to 5% by weight of one or more polymers selected from the group consisting of polylactic acid, polycaprolactone, polyhydroxyalkanoate, chitosan, gluten, one or more polybutylene succinate, polybutylene succinate adipate, polybutylene succinate sebacate, and polybutylene terephthalate-co-adipate.

14. The polyester blend according to claim 12 comprising
40% to 70% by weight of said polyester and
60% to 30% by weight of said one or more polymers selected from the group consisting of polylactic acid and polyhydroxyalkanoate, and
0.05% to 2% by weight of said epoxy-containing copolymer based on styrene, acrylic ester and/or methacrylic ester as compatabilizer.

15. The process for the production of adhesives, dispersions, moldings, extruded foams, bead foams, self-supporting film/sheet and film ribbons for nets and fabrics which comprises utilizing the polyester blend according to claim 12.

16. A process for paper coating which comprises which comprises utilizing the polyester blend according to claim 12.

17. A process for extrusion coating or lamination which comprises utilizing the polyester blend according to claim 12.

18. A process for extrusion-blown or injection stretch blow molded bottles and film applications, flexible intermediate bulk containers, mulch sheeting, carrier bags, freezer bags, packaging nets and fabric bags which comprises utilizing the polyester blend according to claim 12.

19. The process as claimed in claim 18, wherein the film applications are for inliners.
